(19) United States
(12) Patent Application Publication
(10) Pub. No.: US 2011/0135809 A1
(43) Pub. Date: Jun. 9, 2011

(54) LIQUID COMPOSITION, METHOD FOR FORMING SULFIDE FILM, METHOD FOR MANUFACTURING LIGHT-EMITTING DEVICE, AND METHOD FOR MANUFACTURING DISPLAY PANEL

(75) Inventors: Junji Ito, Hiratsuka-shi (JP); Tsuyoshi Furuse, Isehara-shi (JP)

(73) Assignee: CANON KABUSHIKI KAISHA, Tokyo (JP)

(21) Appl. No.: 12/959,276

(22) Filed: Dec. 2, 2010

(30) Foreign Application Priority Data
Dec. 9, 2009 (JP) 2009-279909

(51) Int. Cl. B05D 5/06; C09K 11/06

(52) U.S. Cl. 427/67; 252/301.16

(57) ABSTRACT

A liquid composition contains a dispersion medium serving as a liquid and a plurality of sulfide particles serving as solids dispersed in the dispersion medium, and the dispersion medium contains a mercaptocarboxylic acid ester. After the liquid composition is applied to a base member, a sulfide film may be formed by removing at least a part of the dispersion medium from the base member.

### BACKGROUND OF THE INVENTION

1. Field of the Invention

The present invention relates to a liquid composition containing sulfide particles.

2. Description of the Related Art

In general, fluorescent member films used for display panels of FED, PDP, and the like are formed by applying liquid compositions containing fluorescent member particles. The fluorescent member films in the related art have been formed by applying liquid compositions containing fluorescent member particles having particle diameters of about several micrometers through the use of a screen printing method mainly. Japanese Patent Laid-Open No. 2007-125550 discloses a sulfide based fluorescent member paste composition.

### SUMMARY OF THE INVENTION

A liquid composition for coating according to aspects of the present invention contains at least a dispersion medium serving as a liquid and a plurality of sulfide particles serving as solids dispersed in the dispersion medium, wherein the dispersion medium contains at least an organic sulfide having a structure represented by Formula (1) described below.

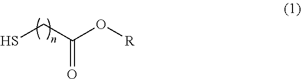

In Formula (1) described above, R represents a substituted or unsubstituted alkyl group having the carbon number of 1 to 18, and n represents 1 or 2.

Further features of the present invention will become apparent from the following description of exemplary embodiments with reference to the attached drawings.

### BRIEF DESCRIPTION OF THE DRAWINGS

FIGS. 1A to 1C are diagrams for explaining examples of display panels.

### DESCRIPTION OF THE EMBODIMENTS

A liquid composition according to aspects of the present invention is a dispersion system (suspension) comprising at least a dispersion medium serving as a liquid and a plurality of sulfide particles serving as solids dispersed in the dispersion medium. The dispersion medium comprises at least an organic sulfide having a structure represented by Formula (1) described below.

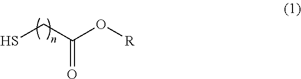

In Formula (1), R represents a substituted or unsubstituted alkyl group having the carbon number of 1 to 18, and n represents 1 or 2. The organic sulfide having a structure represented by Formula (1) is referred to as a “mercaptocarboxylic acid ester”. Hereafter the “mercaptocarboxylic acid ester” is limited to the structure represented by Formula (1) described above.

Aspects of the present invention may address a problem that can occur in a case where sulfide particles are used as fluorescent member particles, in that the sulfide particles may agglomerate in a liquid composition easily as the particle diameters of the sulfide particles are reduced. In particular, the liquid composition according to aspects of the invention can suppress agglomeration of sulfide particles dispersed therein.

The liquid composition is suitable for coating. A sulfide film can be formed by applying the liquid composition to a base member to form a coating film and, thereafter, removing at least a part of the dispersion medium in the coating film. Specifically, the dispersion medium in the coating film may be dried through vaporization to form a dry film. The resulting dry film can be used as the sulfide film. Alternatively, organic materials in the coating film can be thermally decomposed and removed through firing of the coating film, so as to form a fired film. The resulting fired film can be used as the sulfide film. In this regard, before the fired film is formed, the dry film may also be formed by drying the coating film. The thus formed sulfide film is formed from at least sulfide particles. Regarding the sulfide film formed by using the liquid composition according to aspects of the present invention, agglomeration of sulfide particles during the formation process thereof is suppressed, and the secondary particle diameters are small. Consequently, the filling factor of the sulfide particles in the sulfide film is high, and good characteristics can be obtained. The filling factor is specified to be 100×(volume of sulfide particles in sulfide film)/(volume of sulfide film). The volume of the sulfide particles can be calculated from the density of the sulfide particles and the mass of the sulfide particles in the sulfide film. The volume of the sulfide film can be calculated from the thickness and the area of the sulfide film.

It is enough that the dispersion medium comprises at least a mercaptocarboxylic acid ester. In the case where the mercaptocarboxylic acid ester is a liquid at ambient temperature, the dispersion medium may be composed of only the mercaptocarboxylic acid ester. Typically, the dispersion medium comprises an organic solvent, and the mercaptocarboxylic acid ester dissolved in the organic solvent is used. Here, the “organic solvent” refers to an organic compound which is different from the mercaptocarboxylic acid ester and which is a liquid at ambient temperature. The “ambient temperature” refers to 5° C. to 35° C. The dispersion medium may comprise a binder to bond sulfide particles in the coating film. In the case where the coating film is fired, a binder having a good thermal decomposition property is selected. The dispersion medium can comprise a dispersing agent, an antioxidant, a plasticizer, a lubricating agent, an antifoaming agent, and the like besides the mercaptocarboxylic acid ester, the organic solvent, and the binder. The sulfide film may comprise residues of substances contained in the dispersion medium and the above-described binder, antioxidant, and the like as a part of the dispersion medium which is not removed from the coating film. Furthermore, the liquid composition may also comprise particles, e.g., oxide particles (for example, silicon dioxide), which are solids other than the sulfide particles.

The sulfide particles are solid particles of compounds, in which sulfur and an element more positive than sulfur (low electronegativity element) are bonded, among sulfur compounds. The sulfides include oxysulfides, but sulfates are excluded. Examples of sulfide particles include particles of metal sulfides mainly.

As for an example of the sulfide particles, a sulfide particle selected from a first group consisting of SrS:Eu²⁺, SrGa₂S₄, SrCaS:Eu²⁺, ZnS:Ag⁺, CaS:Eu²⁺, ZnS:Cu⁺Al³⁺, La₂O₂S:Eu³⁺, CaAl₂S₄, and BaAl₂S₄:Eu²⁺ can be used. Furthermore, a sulfide particle selected from a second group consisting of Y₂O₂S:Eu³⁺, SrGa₂S₄:Eu²⁺, Sr_{X}Ba_{1-X}Ga₂S₄:Eu²⁺ (0<X<1), ZnS:Ag⁺Al³⁺, and ZnS:Ag⁺Cl⁻ can be used. Moreover, a sulfide particle selected from a third group consisting of Na₈₋₁₀Al₆Si₆O₂₄S₂₋₄, CdS, HgS, and ZnS can be used. The sulfide particles are not limited thereto.

Among the above-described sulfide particles, the sulfide particles of the first group and the second group are fluorescent members which are excited and emit light through irradiation with energy lines, e.g., electron beams, ultraviolet rays, and X-rays, and are referred to as sulfide fluorescent member particles. As for the sulfide particles of the first group, particles having particle diameters of 3 to 10 μm emit light with high brightness. As for the sulfide fluorescent member particles of the second group, not only particles having particle diameters of 3 μm or more, but also particles having particle diameters of less than 3 μm, and furthermore less than 1 μm emit light with high brightness by electron beams. In this regard, Y₂O₂S:Eu³⁺ emits red light, SrGa₂S₄:Eu²⁺ and Sr_{X}Ba_{1-X}Ga₂S₄:Eu²⁺ emit green light, and ZnS:Ag⁺Al²⁺ and ZnS:Ag⁺Cl⁻ emit blue light. The sulfide particles of the third group can be used as pigments. The uses of the sulfide particles are not limited to fluorescent members and pigments. The sulfide particles can be used for formation of sulfide films taking advantage of the properties as a semiconductor, the properties as a catalyst, and the like of metal sulfides. In particular, the liquid composition according to the present embodiment can be used for production of a light-emitting device provided with a fluorescent member film formed from a plurality of sulfide fluorescent member particles. The emission principle of the light-emitting device may be excitation emission based on an electric field, e.g., an inorganic EL device (electroluminescence) besides the above-described excitation emission based on irradiation with energy lines (cathode luminescence, photoluminescence, and scintillation). The emission wavelength is not limited to a visible light region, and may be an infrared region or an ultraviolet region.

The particle diameter (primary particle diameter) of sulfide particles in a powder added to the dispersion medium is not specifically limited, and the range of several nanometers to several hundreds of micrometers can be employed. As the primary particle diameter decreases, the particle diameter (secondary particle diameter) of the sulfide particles in the liquid composition tends to increase, so that an agglomeration suppression effect of inclusion of the mercaptocarboxylic acid ester becomes remarkable. That is, a difference between the primary particle diameter and the secondary particle diameter becomes small. In particular, particles having a particle diameter of 1 μm or less are referred to as sulfide fine particles, and particles having a particle diameter of 100 nm or less are referred to as sulfide nanoparticles. A sulfide film with a finer pattern can be formed by using the sulfide fine particles or the sulfide nanoparticles. By the way, a plurality of sulfide particles refers to a large number of sulfide particles substantially. In the case where the particle diameter (primary particle diameter and secondary particle diameter) of a large number of sulfide particles is concerned, the particle diameter can be specified on a median diameter basis in practice. The median diameter is a statistically determined value and is defined as a particle diameter D, where in the particle diameter distribution, the number of particles having particle diameters larger than the particle diameter D constitutes 50% of the number of total particles. The above-described particle diameter distribution is a distribution of the number of particle diameters based on a sphere equivalent diameter. The particle diameter distribution of the primary particle diameter can be measured through, for example, SEM observation. The particle diameter distribution of the secondary particle diameter can be measured by using a dynamic light scattering method or a laser diffraction scattering method.

As for production of sulfide fine particles and sulfide nanoparticles, a solid phase method, a liquid phase method, a spray pyrolysis method, a gas phase method, and the like can be used. As for the solid phase method, the sulfide particles are mixed and are fired by heating under a high-temperature condition, followed by pulverization with a ball mill or the like, so that sulfide fine particles are formed. As for the liquid phase method, sulfide fine particles are formed through the use of a liquid phase reaction, e.g., a coprecipitation method or a sol-gel method. As for the spray pyrolysis method, a raw material solution is converted to droplets through spraying and heating is performed with a heater in a carrier gas, so that sulfide fine particles are formed through vaporization of a solvent and pyrolysis of the raw material. As for the gas phase method, sulfide fine particles are formed through the use of a gas phase reaction, wherein a sulfide raw material floating in a carrier gas is heated rapidly by being passed through a heating zone based on a heat source, e.g., plasma and is cooled, so that sulfide fine particles are formed.

It is enough that the mercaptocarboxylic acid ester is a compound which is a liquid at ambient temperature or a compound which is a liquid or a solid soluble in an organic solvent. Specific examples of unsubstituted alkyl groups may be linear, branched, or cyclic and are not specifically limited. Examples thereof include a methyl group, an ethyl group, a propyl group, an isopropyl group, a butyl group, an isobutyl group, a sec-butyl group, a tert-butyl group, a pentyl group, an isopentyl group, a tert-pentyl group, a neopentyl group, a hexyl group, an isohexyl group, a heptyl group, an octyl group, a nonyl group, a decyl group, an undecyl group, a dodecyl group, a 2-ethylhexyl group, a tridecyl group, a tetradecyl group, a pentadecyl group, a hexadecyl group, a heptadecyl group, and an octadecyl group.

The substituted alkyl group may have at least one substituent. The substituent usable in the case where the alkyl group has the substituent is not specifically limited. Examples thereof include an alkoxyl group having the carbon number of 16 or less, an aryl group having the carbon number of 16 or less, an allyl group having the carbon number of 16 or less, a carboxyl group, and an oxycarbonyl group represented by —COOA (where A represents an alkyl group having the carbon number of 1 to 16).

Among the mercaptocarboxylic acid esters, examples of compounds with n=2 include methyl-3-mercaptopropionate (where the carbon number of R=1), ethyl-3-mercaptopropionate (where the carbon number of R=2), n-propyl-3-mercaptopropionate (where the carbon number of R=3), methoxybutyl-3-mercaptopropionate (where the carbon number of R=5), 2-ethylhexyl-3-mercaptopropionate (where the carbon number of R=8), n-butyl-3-mercaptopropionate (where the carbon number of R=4), n-octyl-3-mercaptopropionate (where the carbon number of R=8), and stearyl-3-mercaptopropionate (where the carbon number of R=18).

Among the mercaptocarboxylic acid esters, examples of compounds with n=1 include methyl thioglycolate (where the carbon number of R=1), ethyl thioglycolate (where the carbon number of R=2), n-butyl thioglycolate (where the carbon number of R=4), methoxybutyl thioglycolate (where the carbon number of R=5), n-octyl thioglycolate (where the carbon number of R=8), 2-ethylhexyl thioglycolate (where the carbon number of R=8), and stearyl thioglycolate (where the carbon number of R=18).

All the above-described mercaptocarboxylic acid esters can be liquids at ambient temperature.

The mercaptocarboxylic acid ester can be methoxybutyl-3-mercaptopropionate represented by Formula (2) described below, where n=2 and the carbon number=5.

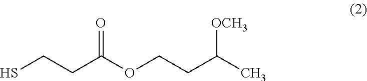

Likewise, the mercaptocarboxylic acid ester can be 2-ethylhexyl-3-mercaptopropionate represented by Formula (3) described below, where n=2 and the carbon number=8.

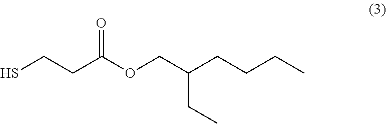

The mercaptocarboxylic acid esters can be changed depending on the type of the sulfide particles. For example, in the case where oxysulfide particles, such as, Y₂O₂S:Eu³⁺, are used as the sulfide particles, the mercaptocarboxylic acid ester having relatively high polarity can be used. Here, the mercaptocarboxylic acid ester having high polarity refers to the mercaptocarboxylic acid ester represented by Formula (1), where R represents an unsubstituted alkyl group or a substituted alkyl group, which have the carbon number of 6 or less. Regarding Y₂O₂S:Eu³⁺, a difference in electronegativity between Y³⁺ and O²⁻ is large and the bond has a high ionic bonding property. Consequently, in the case where the mercaptocarboxylic acid ester having higher polarity is used, the wettability of the fine particle surface becomes better and the mercaptocarboxylic acid ester is adsorbed on the fine particle surface easily. Specifically, methoxybutyl-3-mercaptopropionate represented by Formula (2) described above or the like can be used.

Furthermore, in the case where sulfide particles other than oxide particles, such as, SrGa₂S₄:Eu²⁺, are used as the sulfide particles, the mercaptocarboxylic acid ester having relatively low polarity can be used. Here, the mercaptocarboxylic acid ester having low polarity refers to the mercaptocarboxylic acid ester represented by Formula (2), where R represents a substituted or unsubstituted alkyl group having the carbon number of 7 or more. For example, regarding SrGa₂S₄:Eu²⁺, a difference in electronegativity between Ga³⁺ and S²⁻ is small and the bond has a high covalent bonding property. Consequently, in the case where the mercaptocarboxylic acid ester having lower polarity is used, the wettability of the fine particle surface becomes better and the mercaptocarboxylic acid ester is adsorbed on the fine particle surface easily. Specifically, 2-ethylhexyl-3-mercaptopropionate represented by Formula (3) described above or the like can be used.

Examples of organic solvents can include aromatic hydrocarbon compounds, e.g., toluene and xylene, ether compounds, e.g., tetrahydrofuran and 1,2-butoxyethane, ketone compounds, e.g., acetone, methyl ethyl ketone, 2-heptanone, 4-butyrolactone, and N-methyl-2-pyrrolidinone, ester compounds, e.g., ethyl acetate, butyl acetate, ethyl lactate, diethylene glycol monobutyl ether acetate (BCA), propylene glycol monomethyl ether acetate, dimethyl sebacate, diethyl phthalate, dioctyl phthalate, and tributyl phosphate, alcohol compounds, e.g., isopropyl alcohol, lauryl alcohol, oleyl alcohol, ethylene glycol, diethylene glycol, diethylene glycol monobutyl ether, propylene glycol, dipropylene glycol, dipropylene glycol monomethyl ether, benzyl alcohol, terpineol, and 2-phenoxyethanol, dimethyl sulfoxide, and N,N-dimethylformamide. These compounds may be used alone or in combination.

According to one aspect, it may be that T_{b1}−50≦Tb₂≦Tb₁+50 is satisfied, and it may even be that T_{b1}−50≦T_{b2}≦T_{b1} is satisfied, where the boiling point of the mercaptocarboxylic acid ester is assumed to be T_{b1} (° C.) and the boiling point of the organic solvent is assumed to be T_{b2} (° C.). Here, the “boiling point” refers to a boiling point at 1 atm (normal boiling point). In general, a liquid is vaporized easily as the boiling point thereof becomes lower. Consequently, if the boiling point of the mercaptocarboxylic acid ester is extremely lower than the boiling point of the organic solvent, most of the applied mercaptocarboxylic acid ester is vaporized prior to the organic solvent. As a result, the concentration of the mercaptocarboxylic acid ester in the dispersion medium is reduced significantly, and agglomeration of sulfide particles in the coating film occurs easily. In the case where the boiling point of the organic solvent is at the same level (within ±50° C.) as the boiling point of the mercaptocarboxylic acid ester, the concentration of the mercaptocarboxylic acid ester can be maintained favorably and, thereby, agglomeration of the sulfide particles in the coating film can be suppressed.

Among the above-described mercaptocarboxylic acid esters, the boiling point of ethyl thioglycolate (molecular weight M=120.2) is about 156° C. In this case, the boiling point of the organic solvent may be 106° C. or higher, and 206° C. or lower. According to one aspect, the boiling point of the mercaptocarboxylic acid ester may be 190° C. or higher, and 290° C. or lower. The carbon number of R may be 4 or more. The boiling point of n-butyl thioglycolate (M=148.2), in which the carbon number of R is 4, is about 194° C.

The boiling point of methoxybutyl-3-mercaptopropionate (M=192.28) is about 256° C., and the boiling point of 2-ethylhexyl-3-mercaptopropionate (M=218.36) is about 240° C. The boiling point of diethylene glycol monobutyl ether acetate, among the above-described organic solvents, is about 245° C. Therefore, in the case where the mercaptocarboxylic acid ester is methoxybutyl-3-mercaptopropionate or 2-ethylhexyl-3-mercaptopropionate, diethylene glycol monobutyl ether acetate can be used as the organic solvent.

The coating method is not specifically limited and printing methods, e.g., a screen printing method, an offset printing method, and an ink-jet printing method, a spin coating method, a bar coating method, a dipping method, a slit coating method, and the like can be used. In particular, in the case where a display panel, as described later, is produced, the printing methods can be used. In particular, in the case where the ink-jet method is used, particles in a liquid composition containing sulfide particles can be fine particles and have the median diameter of 1 μm or less in order to discharge the liquid composition from an ink-jet nozzle favorably, and even 400 nm or less.

The viscosity of the liquid composition is adjusted appropriately in accordance with the coating method. For example, in the case where coating is performed by using an ink-jet method, the viscosity of the liquid composition is specified to be 30 mPa·s or less, and typically 10 mPa·s or less. In the case where coating is performed by using a screen printing method, the viscosity of the liquid composition is specified to be 1 Pa·s or more, and 1,000 Pa·s or less, and typically about 100 Pa·s. According to aspects of the present invention, the liquid composition having a viscosity of 30 mPa·s or less is referred to as an ink for the sake of convenience, and the liquid composition having a viscosity of 1 Pa·s or more, and 1,000 Pa·s or less is referred to as a paste for the sake of convenience. In this regard, the viscosity is measured by using a rotary viscometer provided with parallel plate type geometry at a shear rate of 1 (1/s).

Examples of binders having a good thermal decomposition property include acrylic based binders, styrene based binders, cellulose based binders, methacrylic acid ester polymers, styrene-acrylic acid ester copolymers, polystyrenes, polyvinyl butyrals, polyvinyl alcohols, polyethylene oxides, polypropylene carbonates, and polymethyl methacrylates. These binders may be used alone or in combination.

The viscosity of the liquid composition can be adjusted by the materials, e.g., the mercaptocarboxylic acid ester in the dispersion medium, the organic solvent, and the binder. In the case of the paste, terpineol serving as a high viscosity organic solvent, in particular α-terpineol, can be used as the organic solvent. The boiling point of α-terpineol is 218° C. and α-terpineol is mixed with methoxybutyl-3-mercaptopropionate or 2-ethylhexyl-3-mercaptopropionate favorably. As for the binder, a cellulose based polymer, in particular ethyl cellulose, which gives thixotropy to the dispersion medium, can be used. The viscosity of the liquid composition can also be adjusted in accordance with the concentration of sulfide particles in the liquid composition and the blend ratio of the mercaptocarboxylic acid ester, the organic solvent, the binder, and the like in the dispersion medium.

In the liquid composition, the mass of the mercaptocarboxylic acid ester is specified to be 0.1 times or more (10 percent by mass or more), and 10 times or less (1,000 percent by mass or less) larger than the mass of the sulfide particles. If the mass of the mercaptocarboxylic acid ester is less than 10 percent by mass relative to the mass of the sulfide particles, the amount of mercaptocarboxylic acid ester adsorbed on the sulfide particle surface is too small and, thereby, an agglomeration suppression effect is poor. On the other hand, if the amount of mercaptocarboxylic acid ester exceeds 1,000 percent by mass relative to the sulfide particles, the concentration of the sulfide particles in the liquid composition is low and, therefore, it may be necessary to apply a larger amount of liquid composition per unit area. Consequently, the drying time may increase, and the uniformity of the sulfide film is degraded. The mass of the organic solvent may be 100 times or less larger than the mass of the sulfide particles. The mass of components other than that (binder, dispersion medium, and the like) may be 100 times or less larger than the mass of the sulfide particles.

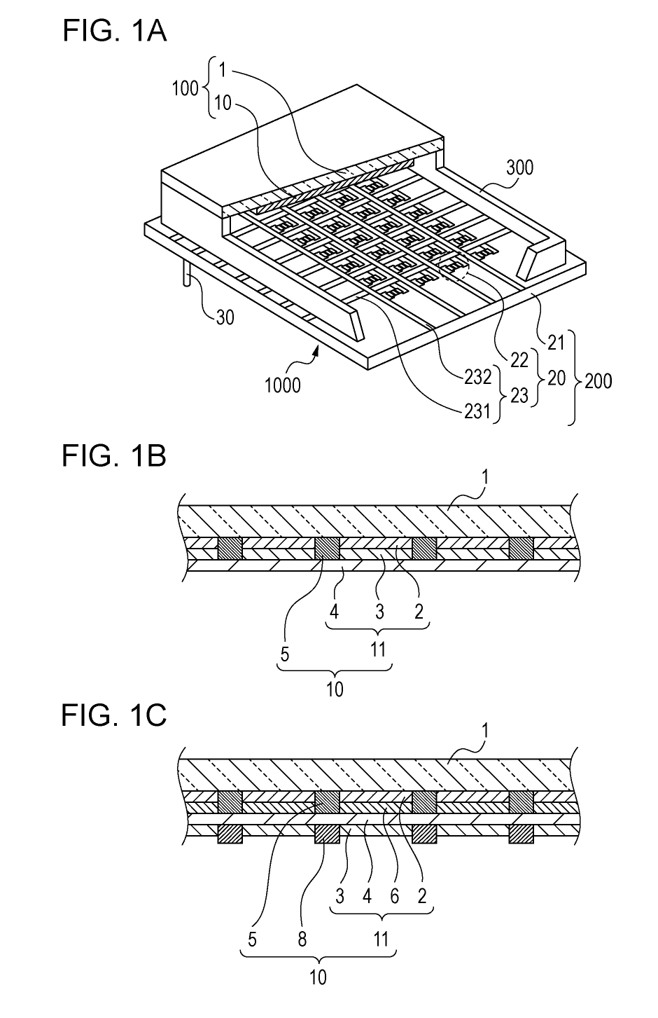

The liquid composition according to aspects of the present invention is used for production of a display panel favorably. An example of display panel (FED) taking advantage of cathode luminescence will be described with reference to FIGS. 1A to 1C.

In FIG. 1A, a display panel 1000 is provided with a display member 10 and an electron source 20, and the display member 10 and the electron source 20 are opposite to each other. In the display panel taking advantage of cathode luminescence, the electron source 20 serves as an excitation member. The display member 10 and the electron source 20 are surrounded by an envelope formed from a transparent substrate 1, an insulating substrate 21, and a frame member 300.

In FIG. 1A, a faceplate 100 is provided with the transparent substrate 1 and the display member 10 disposed on the transparent substrate 1. For details, as shown in FIGS. 1B and 1C, the display member 10 is provided with a plurality of light-emitting devices 11 and light-shielding films 5 arranged in the matrix. Each of the plurality of light-emitting devices 11 is provided with at least a fluorescent member film 3. The plurality of light-emitting devices 11 are separated by a black light-shielding film 5 referred to as a black matrix.

In a first form shown in FIG. 1B, the light-emitting device 11 is provided with a color filter 2 disposed on the transparent substrate 1, the fluorescent member film 3 disposed on the color filter 2, and an anode 4 disposed on the fluorescent member film 3. In the first form, the anode 4 is a metal film referred to as a metal back.

In a second form shown in FIG. 1C, the light-emitting device 11 is provided with a color filter 2 disposed on the transparent substrate 1, an anode 4 disposed on the color filter 2, and the fluorescent member film 3 disposed on the anode 4. In the second form, a transparent electrically conductive film, e.g., ITO, is used for the anode 4.

In the first form and the second form, the color filter 2 may be omitted. However, the color filter 2 can be disposed to increase the purity of foreground color.

In FIG. 1A, a rear plate 200 is provided with the insulating substrate 21 and the electron source 20 disposed on the insulating substrate 21. The electron source 20 is provided with a plurality of electron-emitting devices 22 arranged in the matrix and a matrix wiring 23 connected to the plurality of electron-emitting devices 22. The matrix wiring 23 is composed of vertical wirings 231 and lateral wirings 232, and the vertical wirings 231 and the lateral wirings 232 are insulated from each other with an insulating layer, although not shown in the drawing. The type of electron-emitting device 22 may be an SCE type, a Spindt type, a CNT type, an MIM type, an MIS type, a BSD type, or the like and is not specifically limited.

Electrons are emitted from the electron-emitting devices 22 by applying a drive voltage to the matrix wiring 23. Furthermore, the anode 4 is specified at an anode potential Va through an anode terminal 30 and, thereby, emitted electrons are accelerated and are provided with energy sufficient for allowing fluorescent member particles to emit light. In the form shown in FIG. 1B, electrons are passed through the anode 4 and are applied to the fluorescent member film 3. In the form shown in FIG. 1C, electrons are directly applied to the fluorescent member film 3. The electron-emitting device 22 at a predetermined position is driven by selecting appropriately the vertical wirings 231 and the lateral wirings 232 to apply a drive voltage, so that the light-emitting device 11 at the position opposite to the driven electron-emitting device 22 concerned emits light.

In the case where external light, e.g., interior lighting or sunlight, is incident on a display surface of the display panel, diffuse reflection occurs at the fluorescent member film 3. An observer of the display surface observes the brightness (display brightness) represented by the sum of the diffuse reflection brightness generated through diffuse reflection and the emission brightness of the fluorescent member film 3. In an environment in which the external light is incident, the contrast ratio is specified to be the value obtained by dividing the display brightness by the diffuse reflection brightness. As the illuminance of the external light increases, the diffuse reflection brightness increases, so that the contrast is reduced. Consequently, the diffuse reflectance of the fluorescent member film 3 is reduced.

By the way, in the case where the particle diameter of the fluorescent member particle is less than or equal to the emission wavelength of the fluorescent member particle, the light, which is reflected repeatedly in the inside of the fluorescent member particle and is confined in the inside of the fluorescent member particle, is reduced, so that the proportion of light emitted to the outside of the fluorescent member particle can increase. The above-described emission wavelength is defined as a peak wavelength. In the case where the particle diameter of the fluorescent member particle is reduced, a finer pattern can be formed with high accuracy, so that a high-definition display panel can result. Furthermore, in the case where the filling factor of the fluorescent member particles increases, the diffuse reflection of the fluorescent member film 3 with respect to the external light tends to be reduced. Therefore, the diffuse reflection can be reduced by increasing the filling factor of the fluorescent member particles.

Moreover, the diffuse reflection in the fluorescent member film 3 is also small. Therefore, reflection may be repeated in the fluorescent member film 3 or the transparent substrate 1, and the light emitted from the transparent substrate 1 side toward the observer may become small. Consequently, as shown in FIG. 1C, a photonic crystal structure 6 can be disposed between the anode 4 and the transparent substrate 1. The photonic crystal structure 6 has a structure in which materials having refractive indices different from each other are arranged alternately in a plane parallel to the transparent substrate 1, and can have a structure in which materials having refractive indices different from each other are arranged periodically and alternately in a plane parallel to the transparent substrate 1. In the case where the photonic crystal structure 6 is disposed, the light emitted from the fluorescent member film to the transparent substrate 1 side can be increased and the emission brightness can be made high. Therefore, the diffuse reflection brightness can be reduced and the emission brightness can be made high, so that good display quality can be obtained.

An example of a method for forming the display member 10 in the first form and a method for manufacturing the faceplate 100 will be described. Initially, the transparent substrate 1 is prepared. A liquid composition for a light-shielding layer is applied to the transparent substrate 1 by using a coating method, e.g., a screen printing method. The liquid composition for a light-shielding layer contains an inorganic pigment or an organic pigment. In the case where black sulfide particles are used as the inorganic pigment, the liquid composition for a light-shielding layer can contain a mercaptocarboxylic acid ester. After the applied liquid composition is dried, firing is performed so as to form a light-shielding film 5 having an opening. A liquid composition for a color filter is applied to the transparent substrate 1 in the opening of the light-shielding film 5 by using a coating method, e.g., a screen printing method or an ink-jet printing method. The liquid composition for a color filter contains an inorganic pigment or an organic pigment. In the case where the sulfide particles of the third group are used as the inorganic pigment, the liquid composition for a color filter can contain a mercaptocarboxylic acid ester. After the applied liquid composition is dried, firing is performed so as to form the color filter 2.

Subsequently, a liquid composition for a fluorescent member film is applied to the color filter 2 by using a coating method, e.g., a screen printing method or an ink-jet printing method. As for the liquid composition for a fluorescent member film, the above-described liquid composition containing the sulfide particles of the first group (where SrGa₂S₄ and CaAl₂S₄ are excluded) or the second group serving as the fluorescent member particles and the mercaptocarboxylic acid ester is used. After the applied liquid composition is dried, firing is performed so as to form the fluorescent member film 3.

Then, a filming layer, although not shown in the drawing, is formed on the fluorescent member film 3 by using a coating method, e.g., a screen printing method. Thereafter, a metal film, e.g., aluminum, is formed as the anode 4 on the filming layer by a film forming method, e.g., a sputtering method. The filming layer is removed through thermal decomposition. In this manner, the faceplate 100 provided with the display member 10 can be produced.

An example of a method for forming the display member 10 in the second form and a method for manufacturing the faceplate 100 will be described. The steps up to the step to form the color filter 2 can be performed in a manner similar to those in the first form, and therefore, explanations thereof will be omitted. The photonic crystal structure 6 is formed on the color filter 2 by using a film forming method, e.g., a sputtering method or a working method, e.g., photolithography. Subsequently, a transparent electrically conductive film, e.g., ITO, serving as the anode 4 is formed on the photonic crystal structure 6 by the film forming method, e.g., the sputtering method. Partition members 8 are formed on the anode 4 by using the coating method, e.g., the screen printing method.

Thereafter, a liquid composition for a fluorescent member film is applied to the anode 4 between the partition members 8 by using a coating method, e.g., a screen printing method or an ink-jet method. The liquid composition for a fluorescent member film contains fluorescent member particles. In the case where the ink-jet method is used, as for the fluorescent member particles in the liquid composition, particles (fine particles) having a median diameter of 1 μm or less are used, and even particles having a median diameter of 400 nm or less may be used. The particle diameter of the fluorescent member particles in the fluorescent member film 3 may be less than or equal to the emission wavelength of the fluorescent member film 3, and may even be less than or equal to one-half the emission wavelength. The above-described emission wavelength is defined as a peak wavelength, and the peak wavelength of the fluorescent member film 3 is substantially equal to the peak wavelength of the fluorescent member particles. In the display panel, fluorescent members emitting red, green, and blue light are used typically. Therefore, in the case where the fluorescent member particles having a median diameter of 400 nm or less are used, the ink-jet method can be used and, in addition, high emission brightness can be obtained. Here, agglomeration of sulfide particles can be suppressed by using the above-described liquid composition containing the sulfide particles of the above-described second group serving as the fluorescent member particles and the mercaptocarboxylic acid ester. Therefore, differences in particle diameter are small among the particle diameter (primary particle diameter) of the fluorescent member particles of the powder added to the liquid composition, the particle diameter (secondary particle diameter) of the fluorescent member particles in the liquid composition, and the particle diameter of the fluorescent member particles in the fluorescent member film 3. Consequently, the particle diameter of the fluorescent member particles in the fluorescent member film 3 is reduced effectively. After the applied liquid composition is dried, firing is performed so as to form the fluorescent member film 3. In this manner, the faceplate 100 provided with the display member 10 can be produced.

Then, an example of a method for manufacturing the display panel will be described. The faceplate 100 and the rear plate 200 are arranged with the closed loop-shaped frame member 300 therebetween in such a way that the display member 10 and the electron source 20 are opposite to each other. A method for manufacturing the rear plate 200 is not specifically limited. Each of the faceplate 100 and the rear plate 200 is bonded to the frame member 300 by using a sealing and bonding agent. The anode terminal 30 is electrically connected to the anode 4 while penetrating the insulating substrate 21. The space surrounded by the faceplate 100, the rear plate 200, and the frame member 300 is evacuated. In this manner, the display panel 1000 can be produced.

The examples according to aspects of the present invention will be described below. However, the present invention is not limited to only the following examples.

### Example 1

As for the sulfide particles, a Y₂O₂S:Eu³⁺ powder having a primary particle diameter of 180 nm on a median diameter through SEM observation basis was prepared. As for the dispersing agent, Disperbyk-2000 (trade name), which was a modified acrylic block copolymer produced by BYK, was prepared. As for the mercaptocarboxylic acid ester, methoxybutyl-3-mercaptopropionate (MBMP (trade name) produced by SC Organic Chemical Co., Ltd.) was prepared. As for the organic solvent, diethylene glycol monobutyl ether acetate was prepared.

As for the primary particle diameter of the powder, the diameter of a circle having an area equivalent to the area of each sulfide particle image photographed on the basis of SEM observation was determined, and it was assumed that the photographed sulfide particle had the same volume as the volume of the sphere having the resulting diameter (sphere equivalent diameter). The sphere equivalent diameters of 100 sulfide particles were determined as described above, and the median diameter was calculated from the particle diameter distribution thereof.

A dispersion medium was produced by mixing 2.5 g of methoxybutyl-3-mercaptopropionate, 1.25 g of Disperbyk-2000, and 45 g of diethylene glycol monobutyl ether acetate sufficiently. Subsequently, 5 g of Y₂O₂S:Eu³⁺ powder was added to the dispersion medium, and dispersion was performed with an ultrasonic dispersing machine. In this manner, the liquid composition was produced.

The secondary particle diameter of sulfide particles in the liquid composition was measured by using a particle size measuring machine (Zetasizer Nano (trade name) produced by Malvern). The particles had a median diameter of 210 nm and exhibited monodispersion. That is, agglomeration was suppressed in the resulting liquid composition. The viscosity of the resulting liquid composition was measured with a parallel plate viscometer (AR2000 produced by TA Instruments). As a result, the viscosity was 5.5 mPa·s at a shear rate of 1 (1/s).

### Example 2

A sulfide film was produced by using the liquid composition produced in Example 1 as an ink. The ink was applied to a glass plate by using a bar coater, and firing was performed by keeping in a firing furnace at 450° C. for 1 hour. The thickness of the resulting sulfide film was 1 μm, and the filling factor of sulfide particles was 48%. The diffuse reflectance of the substrate surface was measured by using a spectrophotometer (SolidSpec-3700 (trade name) produced by SHIMADZU CORPORATION). As a result, the diffuse reflectance was 19%.

### Comparative Example 1

A liquid composition was produced in a manner similar to that in Example 1 except that methoxybutyl-3-mercaptopropionate was not added in Example 1. The secondary particle diameter in the liquid composition was measured. As a result, the median diameter was 260 nm and, therefore, it was made clear that sulfide particles were agglomerated in the liquid composition. Furthermore, the viscosity of the liquid composition was 10.2 mPa·s at a shear rate of 1 (1/s). A sulfide film was produced in a manner similar to that in Example 2. The filling factor was 39%. The diffuse reflectance of the substrate surface was measured. As a result, the diffuse reflectance was 24%, where the film thickness of the sulfide film was 1 μm.

### Example 3

A liquid composition was produced in a manner similar to that in Example 1 except that a SrGa₂S₄:Eu²⁺ powder having a median diameter of 280 nm on a SEM observation basis was used as the sulfide particles, and 2-ethylhexyl-3-mercaptopropionate (EHMP (trade name) produced by SC Organic Chemical Co., Ltd.) was used as the mercaptocarboxylic acid ester. The particle diameter in the liquid composition was measured. As a result, the median diameter was 290 nm. Furthermore, the viscosity of the liquid composition was 6.8 mPa·s at a shear rate of 1 (1/s).

### Comparative Example 2

A liquid composition was produced in a manner similar to that in Example 3 except that 2-ethylhexyl-3-mercaptopropionate was not added in Example 3. The particle diameter in the liquid composition was measured. As a result, the median diameter was 350 nm and, therefore, it was made clear that sulfide particles were agglomerated in the liquid composition. Furthermore, the viscosity of the liquid composition was 11.5 mPa·s at a shear rate of 1 (1/s).

### Example 4

A paste was produced by using a Y₂O₂S:Eu³⁺ powder having a median diameter of 180 nm on a SEM observation basis and serving as the sulfide particles, Disperbyk-2000 produced by BYK serving as the dispersing agent, methoxybutyl-3-mercaptopropionate (MBMP produced by SC Organic Chemical Co., Ltd.) serving as the mercaptocarboxylic acid ester, ethyl cellulose serving as a binder, and diethylene glycol monobutyl ether acetate and α-terpineol serving as the organic solvent.

A mixed solution was produced by adding 17 g of diethylene glycol monobutyl ether acetate and 11 g of α-terpineol to 12 g of methoxybutyl-3-mercaptopropionate and 6 g of Disperbyk-2000, and a dispersion medium was produced by dissolving 10 g of ethyl cellulose. After mixing was performed sufficiently, 24 g of Y₂O₂S:Eu³⁺ powder was added to produce a paste. After dispersion was performed with an agitator and a triple roller mill, it was ascertained with a grind gauge that no agglomerates were observed with respect to 1 μm or more. Furthermore, the viscosity of the resulting paste was 98 Pa·s at a shear rate of 1 (1/s).

### Example 5

A paste was produced in a manner similar to that in Example 4 except that a SrGa₂S₄:Eu²⁺ powder having a median diameter of 280 nm on a SEM observation basis was used as the sulfide particles, and 2-ethylhexyl-3-mercaptopropionate (EHMP produced by SC Organic Chemical Co., Ltd.) was used as the mercaptocarboxylic acid ester.

A mixed solution was produced by adding 22 g of diethylene glycol monobutyl ether acetate and 13 g of α-terpineol to 10 g of 2-ethylhexyl-3-mercaptopropionate and 6 g of Disperbyk-2000, and a dispersion medium was produced by dissolving 11 g of ethyl cellulose. After mixing was performed sufficiently, 20 g of SrGa₂S₄:Eu²⁺ powder was added to produce a paste. After dispersion was performed with an agitator and a triple roller mill, it was ascertained with a grind gauge that no agglomerates were observed with respect to 1 μm or more. Furthermore, the viscosity of the resulting paste was 111 Pa·s at a shear rate of 1 (1/s).

### Example 6

A sulfide film was produced in a manner similar to that in Example 2 except that the paste produced in Example was used. The filling factor was 50%. The diffuse reflectance of the substrate surface was measured. As a result, the diffuse reflectance was 18%, where the film thickness of the sulfide film was 1 μm.

### Comparative Example 3

A paste was produced in a manner similar to that in Example 4 except that 2-ethylhexyl-3-mercaptopropionate (EHMP produced by SC Organic Chemical Co., Ltd.) serving as the mercaptocarboxylic acid ester was not added. After dispersion was performed with an agitator and a triple roller mill, it was ascertained with a grind gauge that agglomerates were observed with respect to 15 μm and, therefore, it was made clear that sulfide particles were agglomerated in the paste. Furthermore, the viscosity of the resulting paste was 125 Pa·s at a shear rate of 1 (1/s). A sulfide film was produced in a manner similar to that in Example 5. The filling factor was 40%. The diffuse reflectance of the substrate surface was measured. As a result, the diffuse reflectance was 24%, where the film thickness of the sulfide film was 1 pm.

### Example 7

A liquid composition was produced by mixing each of the powders of several types of sulfide particles, each of several types of mercaptocarboxylic acid esters, an organic solvent, and a dispersing agent. Furthermore, a liquid composition not containing a mercaptocarboxylic acid ester was produced for the purpose of comparison.

As for the sulfide particles, 1 g each of the Y₂O₂S:Eu²⁺ powder used in Example 1, the SrGa₂S₄:Eu²⁺ powder used in Example 3, and a ZnS:Ag⁺Al²⁺ powder having a median diameter of 260 nm was used.

Liquid compositions 1 to 24 were produced by adding diethylene glycol monobutyl ether (boiling point was about 231° C.) to each powder in such a way that the total mass of the mercaptocarboxylic acid ester and the Liquid composition, the types and the masses of which are shown in Table 1, becomes 15 g.

After each of the resulting Liquid compositions 1 to 24 was applied to a glass substrate, drying was performed to form a dry film, and the filling factor of each dry film was determined. As for the evaluation method, the resulting filling factor was compared with the filling factor of the dry film for comparison formed by using the liquid composition for comparison, and the dry film having the filling factor 110% or more of the filling factor of the dry film for comparison was indicated by a mark ◯, and the dry film having the filling factor more than the filling factor of the dry film for comparison, and less than 110% thereof was indicated by a mark Δ. In this regard, no dry film had a filling factor less than or equal to the filling factor of the dry film for comparison. Furthermore, in every combination, it was ascertained that the diffusion reflectance of the dry film was higher than the diffusion reflectance of the dry film for comparison.

TABLE 1

| Liquid | | | | | |
|---|---|---|---|---|---|
| compo- | Sulfide | Mercaptocarboxylic acid ester | | | Filling |
| sition | particle | n | R | Mass | factor |
| 1 | Y₂O₂S: Eu³⁺ | 1 | —C₂H₅ | 0.1 g | Δ |
| 2 | Y₂O₂S: Eu³⁺ | 1 | —C₂H₅ | 1.0 g | ◯ |
| 3 | Y₂O₂S: Eu³⁺ | 1 | —C₂H₅ | 3.0 g | ◯ |
| 4 | Y₂O₂S: Eu³⁺ | 1 | —C₂H₅ | 10.0 g | ◯ |
| 5 | Y₂O₂S: Eu³⁺ | 1 | —n-C₁₈H₃₇ | 0.1 g | Δ |
| 6 | Y₂O₂S: Eu³⁺ | 1 | —n-C₁₈H₃₇ | 1.0 g | Δ |
| 7 | Y₂O₂S: Eu³⁺ | 1 | —n-C₁₈H₃₇ | 3.0 g | ◯ |
| 8 | Y₂O₂S: Eu³⁺ | 1 | —n-C₁₈H₃₇ | 10.0 g | ◯ |
| 9 | SrGa₂S₄: Eu²⁺ | 1 | —C₂H₅ | 1.0 g | Δ |
| 10 | SrGa₂S₄: Eu²⁺ | 1 | —C₄H₉ | 1.0 g | ◯ |
| 11 | SrGa₂S₄: Eu²⁺ | 1 | —C₃H₆(OCH₃)CH₃ | 1.0 g | ◯ |
| 12 | SrGa₂S₄: Eu²⁺ | 1 | —n-C₁₈H₃₇ | 0.5 g | ◯ |
| 13 | SrGa₂S₄: Eu²⁺ | 2 | —C₂H₅ | 1.0 g | Δ |
| 14 | SrGa₂S₄: Eu²⁺ | 2 | —C₄H₉ | 1.0 g | ◯ |
| 15 | SrGa₂S₄: Eu²⁺ | 2 | —C₃H₆(OCH₃)CH₃ | 1.0 g | ◯ |
| 16 | SrGa₂S₄: Eu²⁺ | 2 | —n-C₁₈H₃₇ | 0.5 g | ◯ |
| 17 | ZnS: Ag⁺Al³⁺ | 1 | —C₂H₅ | 1.0 g | Δ |
| 18 | ZnS: Ag⁺Al³⁺ | 1 | —C₄H₉ | 1.0 g | ◯ |
| 19 | ZnS: Ag⁺Al³⁺ | 1 | —i-C₈H₁₇ | 0.5 g | ◯ |
| 20 | ZnS: Ag⁺Al³⁺ | 1 | —n-C₁₈H₃₇ | 0.5 g | ◯ |
| 21 | ZnS: Ag⁺Al³⁺ | 2 | —C₂H₅ | 1.0 g | Δ |
| 22 | ZnS: Ag⁺Al³⁺ | 2 | —C₄H₉ | 1.0 g | ◯ |
| 23 | ZnS: Ag⁺Al³⁺ | 2 | —i-C₈H₁₇ | 0.5 g | ◯ |
| 24 | ZnS: Ag⁺Al³⁺ | 2 | —n-C₁₈H₃₇ | 0.5 g | ◯ |

Likewise, the sulfide particles other than the above-described sulfide particles were evaluated.

As for the sulfide particles of the first group, liquid compositions were produced in the same manner by using powders having primary particle diameters of about 5 μm on a radian diameter basis. The secondary particle diameter measured by a laser diffraction scattering method agreed well with the primary particle diameters on a median diameter basis.

As for Sr_{X}Ba_{1-X}Ga₂S₄:Eu²⁺, which was the sulfide particle of the second group, the same result as that of SrGa₂S₄:Eu²⁺ was obtained, although there was a difference in that a part of Sr of SrGa₂S₄:Eu²⁺ was substituted with Ba, which is an alkaline earth metal element as with Sr. As for ZnS:Ag⁺Cl⁻, the same result as that of ZnS:Ag⁺Al³⁺ was obtained, although there was a difference in dopant when compared with ZnS:Ag⁺Al³⁺.

As for CdS and HgS, which were included in the third group and which are group 12 metal sulfides as with ZnS, the same result as that of ZnS was obtained.

The mercaptocarboxylic acid ester can be synthesized through an esterification reaction between mercaptocarboxylic acid and aliphatic alcohol. It is believed that a mercapto group in the mercaptocarboxylic acid ester synthesized through this esterification reaction does not benefit easily from the electron-attracting effect of the ester group and polarization occurs easily in such a way that the sulfur atom is negative and the hydrogen atom is positive. Consequently, it is estimated that the sulfur atom is oriented to the metal atom on the particle surface, the hydrogen atom is oriented to the sulfur atom and, thereby, agglomeration is suppressed.

A compound having a similar structure can be synthesized through esterification reaction between an aliphatic carboxylic acid and a mercapto-substituted aliphatic alcohol. However, the mercapto group in this compound benefits easily from the electron-attracting effect of the ester group. Consequently, it is estimated that the electron density of the sulfur atom is reduced, polarization of the sulfur atom and the hydrogen atom is weakened, the adsorbing property to the sulfide fine particle surface is weakened, and an agglomeration suppression effect is small.

### Example 8

In the present example, the ink produced in Example 1 was used, the ink-jet method was used and, thereby, the fluorescent member film 3 of the faceplate 100 having the photonic structure 6 was formed. In this regard, in order to examine the emission brightness and the diffusion reflection brightness of the fluorescent member film 3, the color filter 2, light-shielding film 5, and partition members 8 shown in FIG. 1C were omitted. The production steps of the faceplate 100 will be described below.

A large number of depressions in the shape of a nearly circular cylinder were formed into the shape of a two-dimensional rectangular lattice on a quartz glass substrate 1. The pitch between the depressions was specified to be 1,700 nm, the diameter of the depression was specified to be 920 nm, and the depth of the depression was specified to be 880 nm. The refractive index of the quartz glass substrate was 1.46. Subsequently, a TiO₂ film was deposited through the use of titanium tetrachloride by a chemical vapor deposition method (CVD method), so as to be filled in the depressions. The refractive index of the TiO₂ film was 2.2. Thereafter, annealing was performed. Then, surface polishing was performed by a chemical mechanical polishing method (CMP method). The depth of the depression after being subjected to the surface polishing was 670 nm. In this manner, the photonic structure 6 was formed. Subsequently, 250 nm of ITO film serving as the anode 4 was deposited on the photonic crystal structure 6 by using a sputtering method. The refractive index of the ITO film was 1.9.

Next, the ink produced in Example 1 was applied to the ITO film by using the ink-jet method. Thereafter, firing was performed at 550° C. for 1 hour. The thickness of the fluorescent member film 3 after firing was 820 nm.

A rear plate 200 provided with the electron source 20 by a known method was prepared. The faceplate 100 and the rear plate 200 were sealed and bonded with a frame member 300 therebetween in a vacuum chamber. In this manner, a display panel 1000 was produced.

Subsequently, the emission brightness and the diffusion reflection brightness of the display panel 1000 were measured. An anode potential of 10 kV was applied to the anode 4, and a drive pulse having a pulse width of 20 μsec and a pulse frequency of 100 Hz was applied to electron-emitting devices 22 through a matrix wiring 23, so that electrons were emitted from the electron-emitting devices 22. This pulse current density was 4.1 mA/cm². The fluorescent member film 3 emitted red light. Furthermore, a display panel for the purpose of comparison was produced by using the ink produced in Comparative example 1 and by using a faceplate 100 produced in the same manner.

The display panel 1000 formed in the present example and the display panel for comparison were allowed to emit light in a dark room. As a result, the emission brightness of the display panel by using the ink of Example 1 was higher than that of the display panel for comparison. Moreover, in the state in which the external light was present, display was performed while a drive pulse was applied to only the electron-emitting devices 22 in the right-half region of the display panel. As a result, regarding the display panel by using the ink of Example 1, the left-right contrast ratio on the screen was high and good legibility was obtained as compared with the display panel for comparison. In addition, changes in contrast ratio of the display panel by using the ink of Example 1 associated with a stepwise increase in illuminance of the external light were small as compared with those of the display panel for comparison.

Thus, according to an aspect of the present invention, agglomeration of sulfide particles in the liquid composition can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-279909 filed Dec. 9, 2009, which is hereby incorporated by reference herein in its entirety.

What is claimed is:

1. A liquid composition comprising:
a dispersion medium serving as a liquid; and
a plurality of sulfide particles serving as solids dispersed in the dispersion medium,
wherein the dispersion medium comprises at least an organic sulfide having a structure represented by Formula (1) described below 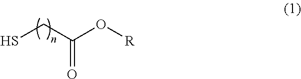
wherein in Formula (1), R represents a substituted or unsubstituted alkyl group having the carbon number of 1 to 18, and n represents 1 or 2.

2. The liquid composition according to claim 1, wherein the sulfide particles are oxysulfide particles and the carbon number of R in the organic sulfide is 6 or less, or the sulfide particles are sulfide particles other than oxide particles and the carbon number of R in the organic sulfide is 7 or more.

3. The liquid composition according to claim 1,
wherein the organic sulfide is a liquid at ambient temperature,
the dispersion medium comprises an organic compound which is different from the organic sulfide and which is a liquid at ambient temperature, and
T_{b1}−50≦T_{b2}≦T_{b1}+50 is satisfied, where the boiling point of the organic sulfide is assumed to be T_{b1} (° C.) and the boiling point of the organic compound is assumed to be T_{b2} (° C.).

4. The liquid composition according to claim 1, wherein the organic sulfide is an organic sulfide having a structure represented by Formula (2) described below or the organic sulfide is an organic sulfide having a structure represented by Formula (3) described below

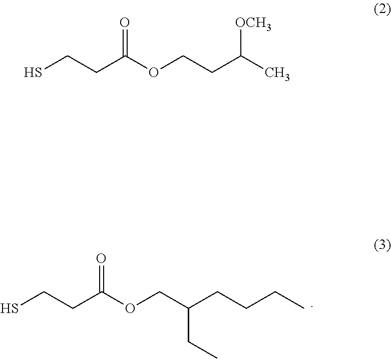

5. The liquid composition according to claim 4, wherein the dispersion medium comprises diethylene glycol monobutyl ether acetate.

6. The liquid composition according to claim 1, wherein the mass of the organic sulfide is 0.1 times or more, and 10 times or less larger than the mass of the sulfide particles.

7. The liquid composition according to claim 1, wherein the median diameter of the plurality of sulfide particles is 1 μm or less.

8. The liquid composition according to claim 1, wherein the sulfide particles are sulfide fluorescent member particles.

9. A method for forming a sulfide film, the method comprising the steps of:
applying the liquid composition according to claim 1 to a base member; and
removing at least a part of the dispersion medium from the base member.

10. The method for forming a sulfide film, according to claim 9, wherein the sulfide particles are oxysulfide particles and the carbon number of R in the organic sulfide is 6 or less, or the sulfide particles are sulfide particles other than oxide particles and the carbon number of R in the organic sulfide is 7 or more.

11. The method for forming a sulfide film, according to claim 9, wherein the median diameter of the plurality of sulfide particles is 1 μm or less.

12. The method for forming a sulfide film, according to claim 9, wherein the applying of the liquid composition is performed by using an ink-jet method.

13. A method for manufacturing a light-emitting device provided with a fluorescent member film, the method comprising the steps of:
applying the liquid composition according to claim 8 to a base member; and
removing at least a part of the dispersion medium from the base member.

14. The method for manufacturing a light-emitting device, according to claim 13, wherein the sulfide particles are oxysulfide particles and the carbon number of R in the organic sulfide is 6 or less, or the sulfide particles are sulfide particles other than oxide particles and the carbon number of R in the organic sulfide is 7 or more.

15. The method for manufacturing a light-emitting device, according to claim 13, wherein the median diameter of the plurality of sulfide particles is 1 μm or less.

16. The method for manufacturing a light-emitting device, according to claim 13, wherein the applying of the liquid composition is performed by using an ink-jet method.

17. A method for manufacturing a display panel provided with a display member including a fluorescent member film and an electron source opposite to the display member, the method comprising the step of:
forming the fluorescent member film by using the liquid composition according to claim 8.

18. The method for manufacturing a display panel, according to claim 17, wherein the sulfide particles are oxysulfide particles and the carbon number of R in the organic sulfide is 6 or less, or the sulfide particles are sulfide particles other than oxide particles and the carbon number of R in the organic sulfide is 7 or more.

19. The method for manufacturing a display panel, according to claim 18, wherein the median diameter of the plurality of sulfide particles is smaller than or equal to the emission wavelength of the fluorescent member film.

20. The method for manufacturing a display panel, according to claim 19, comprising the steps of:
applying the liquid composition to a transparent substrate by using an ink-jet method; and
removing at least a part of the dispersion medium from the transparent substrate.
